(19) United States
(12) Patent Application Publication
(10) Pub. No.: US 2026/0215467 A1
(43) Pub. Date: Jul. 30, 2026

(54) FORMULATIONS AND METHODS FOR DELIVERING DIETARY AND PHARMACEUTICAL INGREDIENTS

(71) Applicant: Gelteq Limited, Caulfield (AU)

(72) Inventors: Nathan Jacob Givoni, Caulfield (AU); Julie Huynh, Caulfield (AU); Paul Michael Wynne, Caulfield (AU); Kristina Tolotchkov, Caulfield (AU)

(21) Appl. No.: 19/142,175

(22) PCT Filed: Dec. 22, 2023
(86) PCT No.: PCT/IB2023/063180

§ 371 Date: Jun. 20, 2025

(30) Foreign Application Priority Data
Dec. 22, 2022 (GB) 2219597.8

(51) Int. Cl. A23L 29/256; A23B 2/754; A23L 21/15; A23L 29/00; A23L 29/231; A23L 33/00

(52) U.S. Cl. CPC A23L 29/256; A23B 2/754; A23L 21/15; A23L 29/015; A23L 29/035; A23L 29/231; A23L 33/30

(57) ABSTRACT

A base gel formulation is disclosed that in one approach conforms with the International Dysphagia Diet Standardisation Initiative (IDDS) 2019. The base gel formulation includes a plurality of gelling agents, water, a pH modifying agent, and a preservative. The gelling agents comprise one each of agar, alginate, as a primary gelling agent, and low methoxy pectin, together with together with at least one divalent cation.

### CROSS-REFERENCE TO RELATED APPLICATIONS

This application claims priority to International Patent Application No. PCT/IB2023/063180 filed Dec. 22, 2023, which also claims priority to Great Britain Patent Application GB 2219597.8 filed Dec. 22, 2022, the contents of each of which is hereby incorporated by reference in its entirety.

### TECHNICAL FIELD

This invention relates to formulations and methods for delivering dietary and pharmaceutical ingredients to patients with swallowing difficulties or dysphagia.

### BACKGROUND

Patients with dysphagia have problems swallowing food and drink. As a consequence, dietary and pharmaceutical ingredients need to be delivered in a form that facilitates their uptake.

Whilst there are products on the market which are tailored to delivering particular ingredients to particular patient groups it would be advantageous to patients and their carers if there was a “base formulation” that could facilitate the uptake of a wide range of different dietary and pharmaceutical ingredients in a form that complies with the International Dysphagia Diet Standardisation Initiative (IDDSI) 2019—see https://iddsi.org/IDDSI/media/images/Complete_IDDSI_Framework_FInal_31July2019.pdf, which document is incorporated by reference and pages 2 to 10 of which are appended as Annex 1.

Applicant has previously disclosed in WO2019215641, a gel formulation comprising agar (the primary gelling agent) and alginate which when sucked shears releasing water to facilitate uptake. However, the agar can form “plugs” which can present a choking hazard to dysphagic patients. In contrast the present invention utilises an alginate (together with selected divalent cations) as the primary gelling agent, with a different gelling mechanism to agar, to cause gelling and largely enable it to comply with the IDDSI framework for producing gels with a type 1 to 4 texture. However, such a gelling agent alone could not achieve the required textures, and it was necessary to utilise other gelling agents (secondary and tertiary gelling agents) with different gelling mechanisms and select given cationic compounds to achieve the desired results.

Other art identified includes:

EP3257528 which discloses a jelly incorporating a drug for people with swallowing difficulties. It utilises low methoxy (LM) pectin as the primary gelling agent and the approach and end product differs significantly from the claimed invention.

JPS6265652 which discloses a citrus fruit endocarb-like food comprising agar and xanthan gum as the primary gelling agents and would not give rise to the soft gels of the claimed invention.

JP2018027901 which discloses compositions in which the primary gelling agent is low methoxy pectin which cannot achieve the textures of the claimed invention.

JP200325041 which similarly relies on low methoxy pectin which cannot achieve the textures of the claimed invention.

JP2016202158 which discloses jelly containing beverages and utilises LM pectin and alginate interchangeably, alone or together to produce the gels.

None of this art gives rise to, or would lead the skilled person, to a product as claimed and as set out in more detail below.

### SUMMARY

In accordance with the present inventions there is provided a base gel formulation, conforming with the International Dysphagia Diet Standardisation Initiative 2019 (IDDSI) comprising:
a plurality of gelling agents;
water;
a pH modifying agent;
a preservative; and optionally
a flavouring

characterised in that the plurality of gelling agents comprises one each of:
agar;
alginate, as a primary gelling agent; and
low methoxy pectin

together with at least one divalent cation.

The base formulation of the invention provides products with thicknesses described under the IDDSI framework as “drinks” including those defined as:
(1) slightly thick;
(2) mildly thick;
(3) moderately thick; and
(4) extremely thick.

The invention is based around combining three specific gelling agents, together with a divalent ion, to provide a base with a desired texture range which is stable.

The three gelling agents are:
(a) agar—for strength and stability;
(b) alginate—for softness; and
(c) low methoxy pectin—for smoothness.

The latter two gelling agents require
(d) a divalent cation—to gel.

Applicant has surprisingly determined that it is essential for the alginate to be the primary gelling agent (present in the greatest amount) and that the divalent cation, in the form of a gluconate, has advantages over the industry standard gelling agent, calcium chloride.

This could not have been predicted.

The other components of the base gel drink include:
(e) water;
(f) a pH modifying agent;
(g) a preservative; and optionally
(h) a flavouring.

By careful control of the respective concentrations of the three gelling agents the formulation can be modified to achieve a formulation that meets the IDDSI thickness criteria (1) to (4).

As shown in Annex 1 each of the type 1 to 4 products are classified as drinks (though products 3 and 4 can also be considered as foods) based on defined syringe testing methods.

Thus, the generic base formulation comprises gelling agents and a divalent cation in % amounts (by weight) of the base formulation as set out in Table 1a. The base formulation further including to non-gelling agent components including water.

| Gelling agents | Weight % |
|---|---|
| Agar | 0.01 to 0.60 |
| Alginate | 0.05 to 2.00 |
| Low methoxy pectin | 0.01 to 0.50 |
| Divalent cation | 0.05 to 1.50 |

In one embodiment the formulation is free of a flavouring as set out in Table 1b.

| Gelling agents | Weight % |
|---|---|
| Agar | 0.01 to 0.60 |
| Alginate | 0.05 to 1.70 |
| Low methoxy pectin | 0.05 to 0.50 |
| Divalent cation | 0.05 to 1.50 |

In another embodiment the formulation includes a flavouring as set out in Table 1c.

| Gelling agent | Weight % |
|---|---|
| Agar | 0.01 to 0.10 |
| Alginate | 0.40 to 2.00 |
| Low methoxy pectin | 0.01 to 0.40 |
| Divalent cation | 0.10 to 1.20 |

A natural flavouring, such as, e.g. orange juice, may contain natural gelling agents which can impact the actual amounts of the primary, secondary and tertiary gelling agents.

Favoured generic base formulations are illustrated in Table 1d (with a natural flavouring—e.g. orange juice) and Table 1e (no flavouring).

TABLE 1d

| | Weight % |
|---|---|
| Gelling agents | |
| Agar | 0.01 to 1.00 |
| Alginate | 0.40 to 2.00 |
| Low methoxy pectin | 0.01 to 0.40 |
| Divalent cation | 0.10 to 1.20 |
| Non gelling agents | |
| pH modifying agent e.g. Sodium | 0.20 to 0.50 |
| hydroxide | |
| Preservative e.g. Potassium sorbate | 0.02 to 0.06 |
| Water (including flavouring) | to 100% |

TABLE le

| | Weight % |
|---|---|
| Gelling agents | |
| Agar | 0.01 to 0.60 |
| Alginate | 0.05 to 1.70 |
| Low methoxy pectin | 0.05 to 0.50 |
| Divalent cation | 0.05 to 1.50 |
| Non gelling agents | |
| pH modifying agent e.g. Citric acid | 0.02 to 0.05 |
| Preservative e.g. Potassium sorbate | 0.05 to 0.07 |
| Water | to 100% |

Thus, a formulation complying with IDDSI thickness criteria (1) comprises a formulation as set out in Table 2a (Gelling agents of base formulation), Table 2b (with a natural flavouring—e.g. orange juice) and 2c (no flavouring).

TABLE 2a

| Gelling agent | Weight % |
|---|---|
| Agar | 0.01 to 0.20 |
| Alginate | 0.05 to 0.80 |
| Low methoxy pectin | 0.20 to 0.40 |
| Divalent cation | 0.10 to 1.20 |

TABLE 2b

| | Weight % | Pref % |
|---|---|---|
| Gelling agent | | |
| Agar | 0.01 to 0.03 | 0.02 |
| Alginate | 0.40 to 0.80 | 0.47 to 0.78 |
| Low methoxy pectin | 0.30 to 0.33 | 0.31 to 0.32 |
| Divalent cation | 0.10 to 1.20 | 0.16 to 1.17 |
| Non gelling agents | | |
| pH modifying agent e.g. Sodium | 0.20 to 0.50 | 0.39 to 0.47 |
| hydroxide | | |
| Preservative e.g. Potassium sorbate | 0.02 to 0.06 | 0.04 |
| Water (including flavouring) | to 100% | to 100% |

TABLE 2c

| | Weight % | Pref % |
|---|---|---|
| Gelling agent | | |
| Agar | 0.02 to 0.20 | 0.11 |
| Alginate | 0.05 to 0.70 | 0.36 |
| Low methoxy pectin | 0.20 to 0.40 | 0.30 |
| Divalent cation | 0.12 to 0.15 | 0.13 |
| Non gelling agents | | |
| pH modifying agent e.g. Citric acid | 0.02 to 0.02 | 0.02 |
| Preservative e.g. Potassium sorbate | 0.05 to 0.05 | 0.05 |
| Water | to 100% | to 100% |

Thus, a formulation complying with IDDSI thickness criteria (2) comprises a formulation as set out in Table 3a (Gelling agents of base formulation), Table 3b (with a natural flavouring—e.g. orange juice) and 3c (no flavouring).

TABLE 3a

| Gelling agent | Weight % |
|---|---|
| Agar | 0.01 to 0.20 |
| Alginate | 0.35 to 1.00 |
| Low methoxy pectin | 0.20 to 0.40 |
| Divalent cation | 0.10 to 0.80 |

TABLE 3b

| | Weight % | Pref % |
|---|---|---|
| Gelling agent | | |
| Agar | 0.01 to 0.03 | 0.02 |
| Alginate | 0.60 to 0.80 | 0.67 to 0.79 |
| Low methoxy pectin | 0.30 to 0.32 | 0.31 |
| Divalent cation | 0.10 to 0.80 | 0.20 to 0.59 |
| Non gelling agents | | |
| pH modifying agent e.g. | 0.20 to 0.50 | 0.47 |
| Sodium hydroxide | | |
| Preservative e.g. Potassium | 0.02 to 0.06 | 0.04 |
| sorbate | | |
| Water (including | to 100% | to 100% |
| flavouring) | | |

TABLE 3c

| | Weight % | Pref % |
|---|---|---|
| Gelling agent | | |
| Agar | 0.02 to 0.20 | 0.11 |
| Alginate | 0.35 to 1.00 | 0.66 |
| Low methoxy pectin | 0.20 to 0.40 | 0.30 |
| Divalent cation | 0.10 to 0.40 | 0.24 |
| Non gelling agents | | |
| pH modifying agent e.g. | 0.02 to 0.02 | 0.02 |
| Citric acid | | |
| Preservative e.g. Potassium | 0.05 to 0.05 | 0.05 |
| sorbate | | |
| Water | to 100% | to 100% |

Thus, a formulation complying with IDDSI thickness criteria (3) comprises a formulation as set out in Table 4a (Gelling agents of base formulation), Table 4b (with a natural flavouring—e.g. orange juice) and 4c (no flavouring).

TABLE 4a

| Gelling agent | Weight % |
|---|---|
| Agar | 0.01 to 0.2 |
| Alginate | 0.40 to 1.60 |
| Low methoxy pectin | 0.05 to 0.50 |
| Divalent cation | 0.05 to 0.65 |

TABLE 4b

| | Weight % | Pref % |
|---|---|---|
| Gelling agent | | |
| Agar | 0.01 to 0.09 | 0.02 |
| Alginate | 0.70 to 1.40 | 0.78 to 1.37 |
| Low methoxy pectin | 0.30 to 0.40 | 0.31 |
| Divalent cation | 0.30 to 0.65 | 0.31 to 0.61 |
| Non gelling agents | | |
| pH modifying agent e.g. | 0.20 to 0.50 | 0.23 to 0.47 |
| Sodium hydroxide | | |
| Preservative e.g. Potassium | 0.02 to 0.06 | 0.04 |
| sorbate | | |
| Water (including | to 100% | to 100% |
| flavouring) | | |

TABLE 4c

| | Weight % | Pref % |
|---|---|---|
| Gelling agent | | |
| Agar | 0.01 to 0.20 | 0.11 |
| Alginate | 0.40 to 1.60 | 0.98 |
| Low methoxy pectin | 0.05 to 0.50 | 0.28 |
| Divalent cation | 0.05 to 0.40 | 0.21 |
| Non gelling agents | | |
| pH modifying agent e.g. | 0.02 to 0.02 | 0.02 |
| Citric acid | | |
| Preservative e.g. Potassium | 0.05 to 0.05 | 0.05 |
| sorbate | | |
| Water | to 100% | to 100% |

Thus, a formulation complying with IDDSI thickness criteria (4) comprises a formulation as set out in Table 5a (Gelling agents of base formulation), Table 5b (with a natural flavouring—e.g. orange juice) and 5c (no flavouring).

TABLE 5a

| Gelling agents | Weight % |
|---|---|
| Agar | 0.05 to 0.60 |
| Alginate | 0.10 to 2.00 |
| Low methoxy pectin | 0.01 to 0.30 |
| Divalent cation | 0.10 to 1.50 |

TABLE 5b

| Gelling agents | Weight % | Pref % |
|---|---|---|
| Agar | 0.08 to 0.10 | 0.09 |
| Alginate | 1.90 to 2.00 | 1.94 to 1.95 |
| Low methoxy pectin | 0.01 to 0.20 | 0.01 to 0.19 |
| Divalent cation | 0.40 to 0.50 | 0.44 |
| Non gelling agents | | |
| pH modifying agent e.g. | 0.20 to 0.50 | 0.23 |
| Sodium hydroxide | | |
| Preservative e.g. | 0.02 to 0.06 | 0.04 |
| Potassium sorbate | | |
| Water (including | to 100% | to 100% |
| flavouring) | | |

TABLE 5c

| Gelling agents | Weight % | Pref % |
|---|---|---|
| Agar | 0.05 to 0.60 | 0.34 |
| Alginate | 0.10 to 1.70 | 0.88 |
| Low methoxy pectin | 0.10 to 0.30 | 0.23 |
| Divalent cation | 0.10 to 1.50 | 0.24 to 0.40 |
| Non gelling agents | | |
| pH modifying agent e.g. | 0.02 to 0.05 | 0.02 to 0.05 |
| Citric acid | | |
| Preservative e.g. | 0.05 to 0.07 | 0.05 to 0.07 |
| Potassium sorbate | | |
| Water | to 100% | to 100% |

The formulations of the invention preferably comprise as divalent cations, calcium ions.

These are most preferably present in the form calcium gluconate.

The formulations of the invention all have a pH of between pH 4 and pH 6, more preferably still pH 5 to pH 6.

The preferred pH control agents are sodium hydroxide and citric acid.

A preferred preservative is potassium sorbate.

Optionally, the formulation includes a flavouring.

According to a second aspect of the present invention there is provided a base gel formulation which is an IDDSI type 1 to 3 formulation according to a first aspect of the invention packaged in a container which facilitates uptake of the containers contents by drinking or sucking.

Preferably the container is a pouch, sachet or straw.

According to a third aspect of the present invention there is provided a method of providing a patient with dietary and/or pharmaceutical ingredients comprising including the ingredients in an IDDSI type 1 to 3 drinkable base gel formulation according to a first aspect of the invention and allowing the patient to drink or suck the formulation.

An IDDSI type 4 base gel formulation in contrast to the 2^{nd} and 3^{rd} aspects is still consumed without chewing but does not flow freely like a drink.

All 4 types may be delivered in volumes of from 5 mL to 200 mL depending on the dietary and/or pharmaceutical ingredients.

### BRIEF DESCRIPTION OF THE DRAWINGS

Examples demonstrating various aspects of the invention are further described hereinafter with reference to the accompanying drawings, in which:

FIG. 1 illustrates the seven categories of products covered by the IDDSI framework, and

FIGS. 2A-2E—are an extract from the referenced IDDSI document, providing details of syringe testing of type 1 to 4 products.

### DETAILED DESCRIPTION

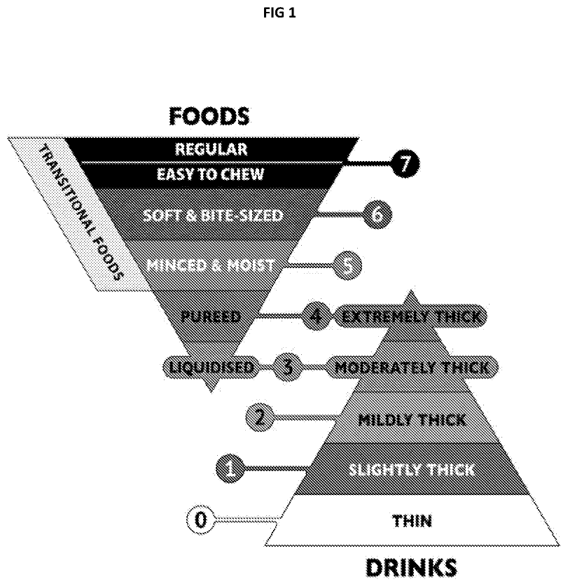

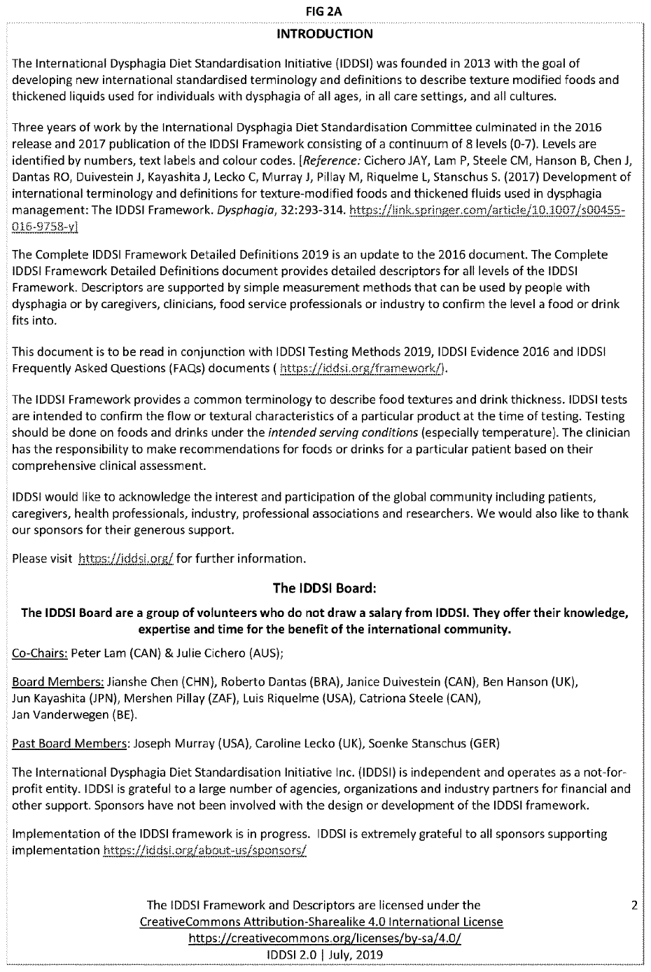

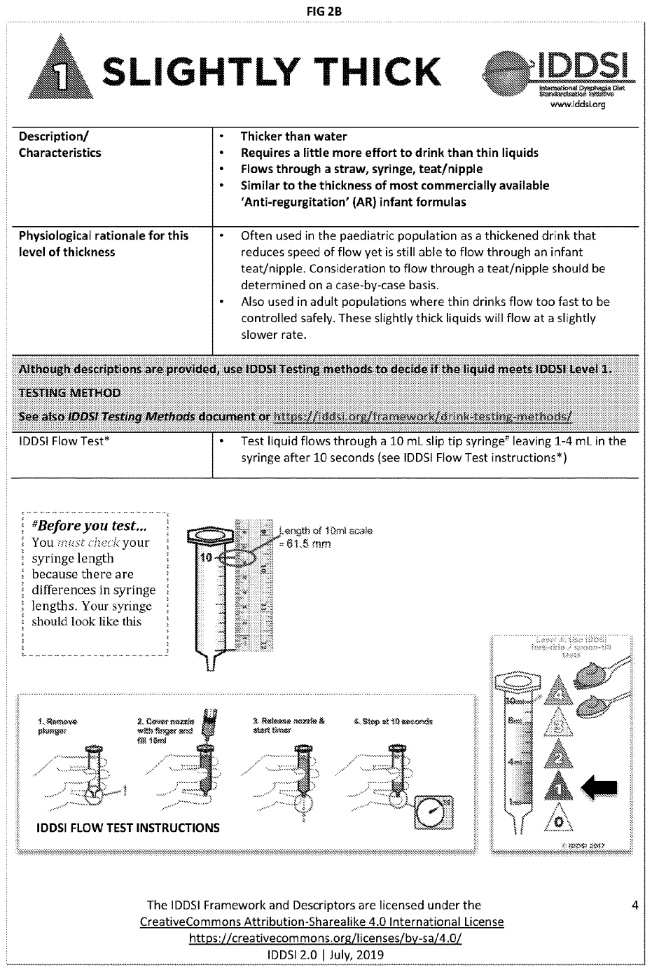

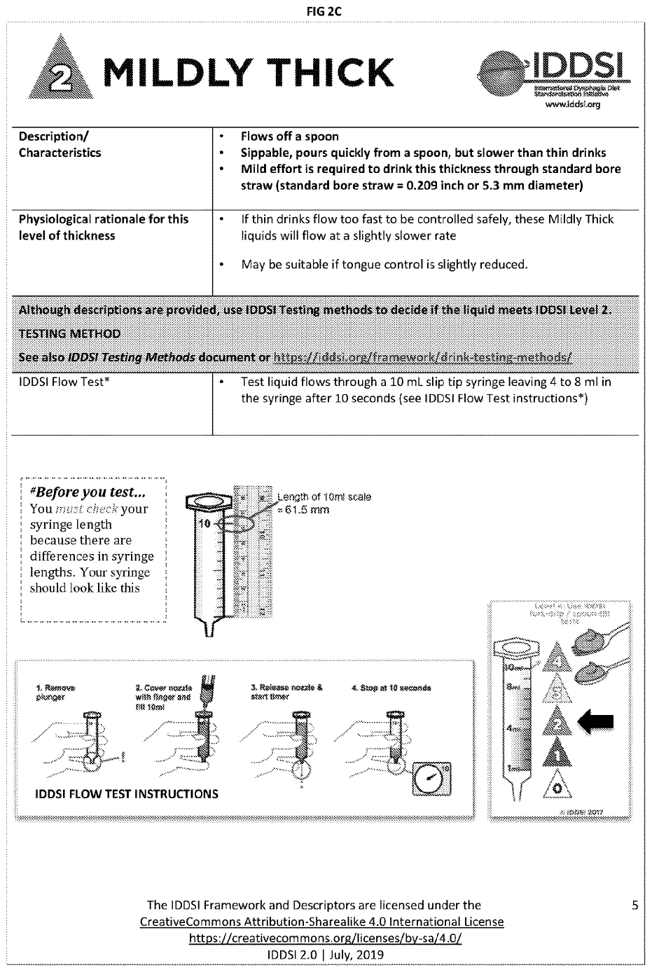

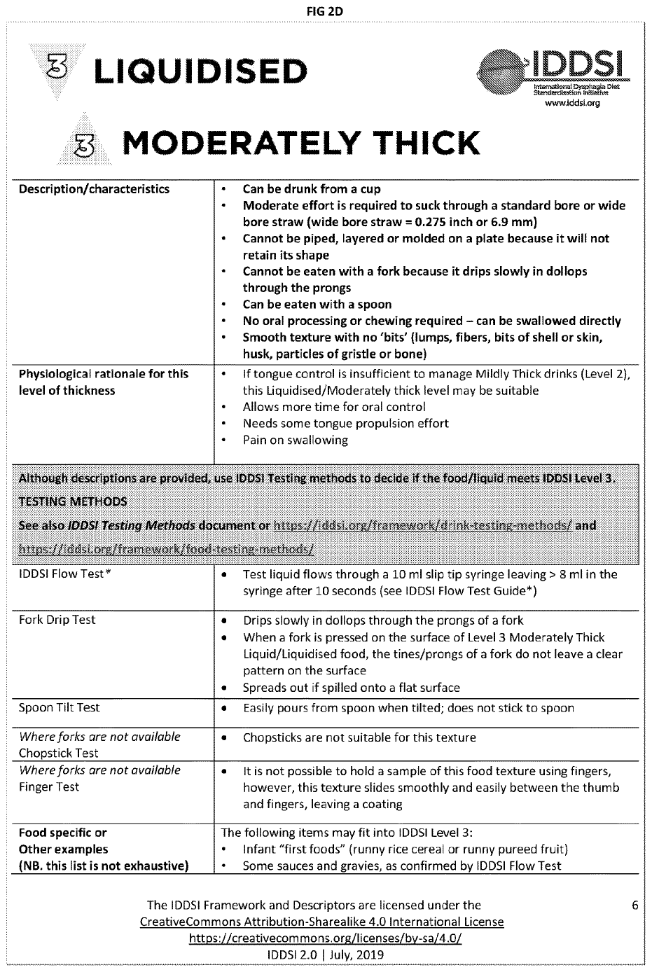

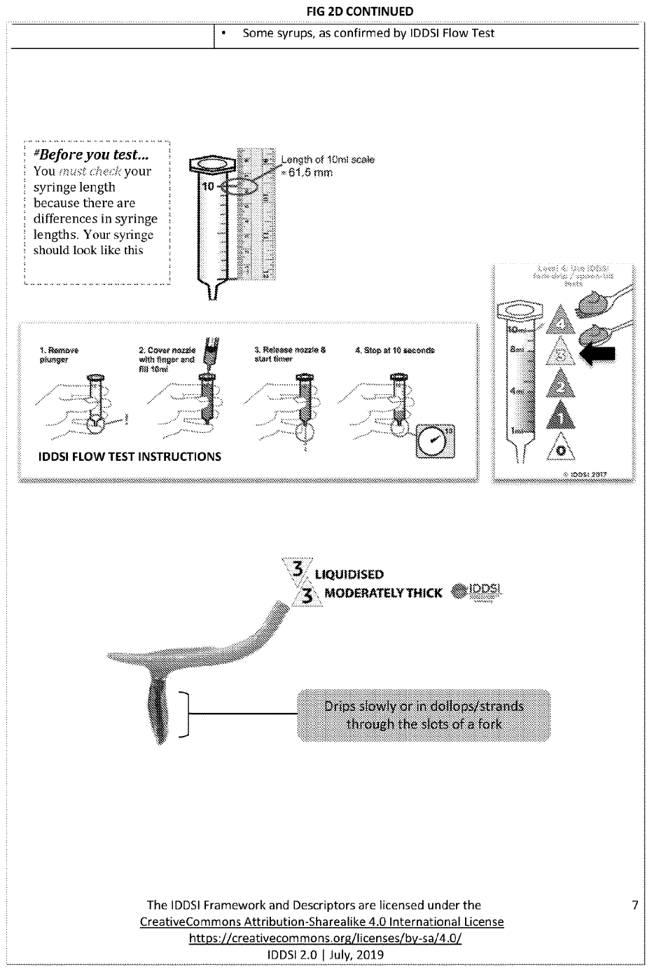

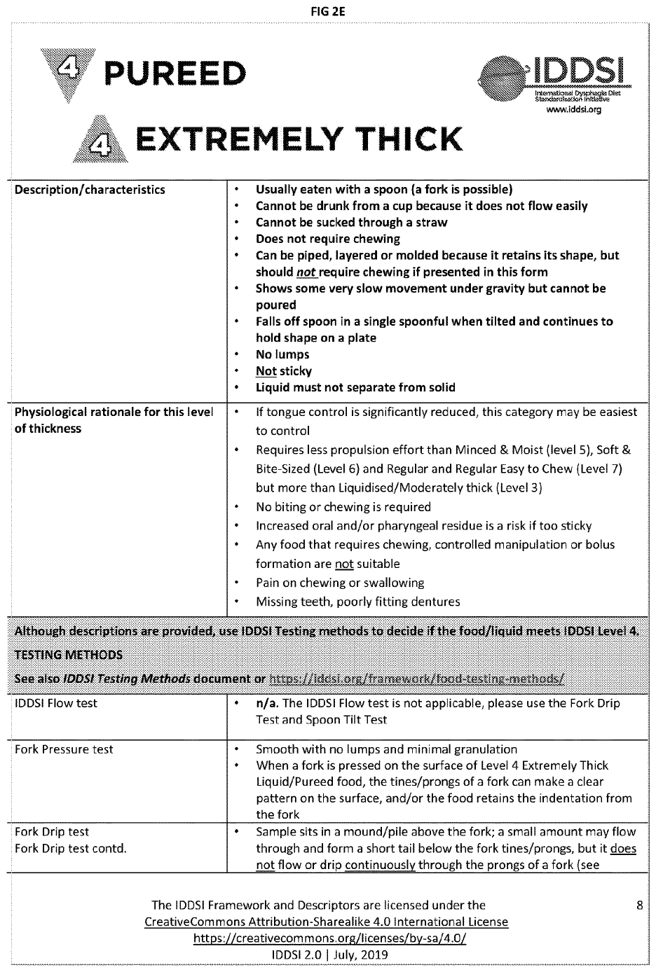

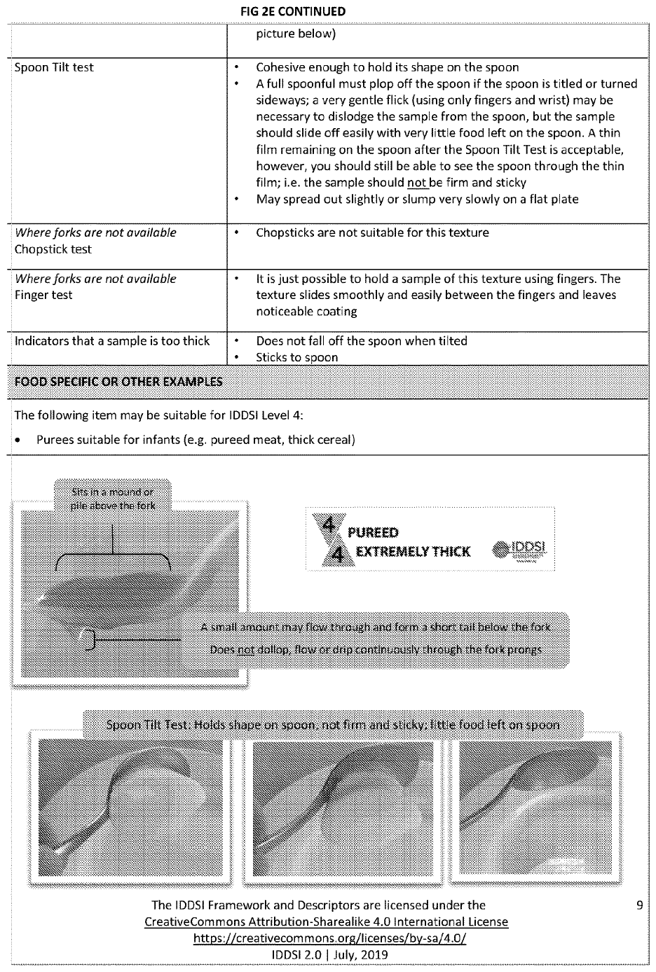

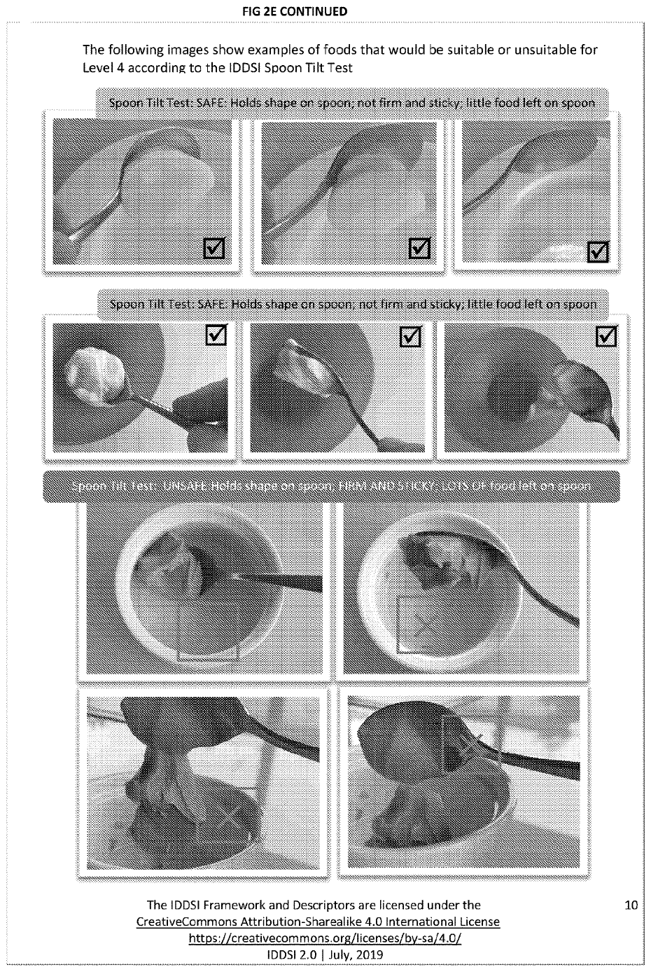

Referring to FIG. 1 the seven categories are classified as foods or drinks. The drinks start at 0 (thin) and become increasingly thicker, to 4 (extremely thick). Categories 3 (moderately thick) and 4 (extremely thick) cross over with the food categories with 3 equating to a liquidised food and 4 equating to a pureed food.

In arriving at the base formulation(s) of the invention applicant undertook a vast number of experiments with a view to finding gelling agents that complemented one another such that they provided a flexible base which could then be adjusted to meet the different requirements of IDDSI “drink” formulations, as defined by categories 1 to 4.

Due to agars ability to “release” water on shearing it was initially considered the ideal candidate. However, as illustrated in Comparative Example 1, agar alone proved unsuitable.

### Comparative Example 1 (Agar)

TABLE 6

| Component | % by wt (range) |
|---|---|
| Gelling agent-agar | 0.40 to 0.90 |
| Preservative-potassium | 0.30 |
| sorbate | |
| pH control-sodium | 0.00 to 0.20 |
| hydroxide | |
| Flavoured water-orange | to 100% |

It was apparent from several experiments conducted within the range indicated that agar alone was too firm and when squeezed generated chunks that did not break up.

Based on this, two alternative gelling agents were trialled (as stand-alone agents) as illustrated in Comparative Examples 2 and 3.

### Comparative Example 2 (Sodium Alginate)

TABLE 7

| Component | % by wt (range) |
|---|---|
| Gelling agent-sodium | 1.00 to 2.90 |
| alginate | |
| Preservative- | 0.30 |
| potassium sorbate | |
| pH control-sodium | 0.00 to 0.20 |
| hydroxide | |
| Divalent cation- | 0.00 to 0.20 |
| calcium chloride | |
| Flavoured | to 100% |
| water-orange | |

It was apparent from the experiments conducted that sodium alginate gels were generally too thin and required thickening.

### Comparative Example 3

TABLE 9

| Component | % by wt. (range) |
|---|---|
| Gelling agent-low | 0.40 to 0.80 |
| methoxy pectin | |
| Preservative- | 0.10 to 0.30 |
| potassium sorbate | |
| pH control-sodium | 0.00 |
| hydroxide | |
| Divalent cation- | 0.20 to 2.90 |
| calcium chloride | |
| Flavoured water- | to 100% |
| orange juice | |

It was apparent from a number of experiments that the low methoxy pectin produced thick and viscous gels. However, they were not as stable as the other stand-alone gels.

What was apparent from each of these standalone gelling agents was that each had shortcomings. Applicant therefore explored whether combinations might be used to address the shortcomings of each alone.

Thus, in furthering the development, the three gelling agents were combined in different amounts, by weight, with a view to achieving products that complied with IDDSI guidelines.

The methodology and favoured formulations are set out below:

### Examples 4 to 7

General Methodology (with a Natural Flavouring—e.g. Orange Juice)

Potassium sorbate, calcium gluconate, sodium hydroxide, flavouring and water were weighed into a beaker and stirred until dissolved. The ingredients were heated until the temperature of the solution reached approximately 95° C. When the temperature reached 95° C., agar and LM pectin were added and the formulation was continuously heated and stirred until dissolved. Slowly, sodium alginate was added and stirred until dissolved. The beaker was then removed from the heating plate and mixed with a high shear laboratory mixer (Silverson® L5M) at 1500-2000 rpm for approximately 2 minutes to obtain a homogenous and smooth formulation. The gel was then left to cool at room temperature. When using the no flavouring formulation, replace sodium hydroxide with citric acid.

### Example 4a (IDDSI Type 1)

Using the methodology described above a Type 1 formulation was made up as per Table 10a below:

| | 1) Slightly Thick | |
|---|---|---|
| Mass | grams | % |
| Orange juice | 50.00 | 98.60 |
| Potassium sorbate | 0.02 | 0.04 |
| Pectin | 0.16 | 0.32 |
| Calcium gluconate | 0.08 | 0.16 |
| Sodium alginate | 0.24 | 0.47 |
| Agar | 0.01 | 0.012 |
| Sodium hydroxide | 0.20 | 0.39 |
| pH | 5.75 | |
| Amount left in | IDDSI | 1.0-4.0 |
| syringe (mL) | Results | 2.6 |

IDDSI Type 1 is described as thicker than water and can flow through a straw and syringe. The IDDSI Flow Test states that the test liquid should flow through a 10 mL slip tip syringe leaving 1-4 mL in the syringe after 10 seconds. The Example 4a formulation had 2.6 mL remaining liquid left in the syringe.

### Example 4b (IDDSI Type 1)

Using the methodology described above a Type 1 formulation was made up as per Table 10b below:

| | 1) Slightly Thick | |
|---|---|---|
| Mass | grams | % |
| Water | 59.42 | 99.03 |
| Potassium sorbate | 0.03 | 0.05 |
| Pectin | 0.18 | 0.30 |
| Calcium gluconate | 0.08 | 0.13 |
| Sodium alginate | 0.22 | 0.36 |
| Agar | 0.07 | 0.11 |
| Citric acid | 0.01 | 0.02 |
| pH | 5.00 | |
| Amount left in | IDDSI | 1.0-4.0 |
| syringe (mL) | Results | 2.5 |

IDDSI Type 1 is described as thicker than water and can flow through a straw and syringe. The IDDSI Flow Test states that the test liquid should flow through a 10 mL slip tip syringe leaving 1-4 mL in the syringe after 10 seconds. The Example 4b formulation had 2.5 mL remaining liquid left in the syringe.

### Example 5a (IDDSI Type 2)

Using the methodology described above a Type 2 formulation was made up as per Table 11a below:

| | (2) Mildly Thick | |
|---|---|---|
| Mass | grams | % |
| Orange juice | 50.00 | 98.25 |
| Potassium sorbate | 0.02 | 0.04 |
| Pectin | 0.16 | 0.31 |
| Calcium gluconate | 0.15 | 0.290 |
| Sodium alginate | 0.35 | 0.69 |
| Agar | 0.01 | 0.02 |
| Sodium hydroxide | 0.20 | 0.39 |
| pH | ND | |
| Amount left in | IDDSI | 4.0-8.0 |
| syringe (mL) | Results | 5.0 |

IDDSI Type 2 is described as a liquid that flows off a spoon, is sippable and only mild effort is required to drink this thickness through a standard straw. The IDDSI Flow Test states that the test liquid should flow through a 10 mL slip tip syringe leaving 4-8 mL in the syringe after 10 seconds. The Example 5a formulation had 5.0 mL of liquid left in the syringe.

### Example 5b (IDDSI Type 2)

Using the methodology described above a Type 2 formulation was made up as per Table 11b below.

| | 2) Mildly Thick | |
|---|---|---|
| Mass | grams | % |
| Water | 59.17 | 98.62 |
| Potassium sorbate | 0.03 | 0.05 |
| Pectin | 0.18 | 0.30 |
| Calcium gluconate | 0.14 | 0.24 |
| Sodium alginate | 0.40 | 0.66 |
| Agar | 0.07 | 0.11 |
| Citric acid | 0.01 | 0.02 |
| pH | 5.00 | |
| Amount left in | IDDSI | 4.0-8.0 |
| syringe (mL) | Results | 6.0 |

IDDSI Type 2 is described as a liquid that flows off a spoon, is sippable and only mild effort is required to drink this thickness through a standard straw. The IDDSI Flow Test states that the test liquid should flow through a 10 mL slip tip syringe leaving 4-8 mL in the syringe after 10 seconds. The Example 5b formulation had 6.0 mL of liquid left in the syringe.

### Example 6a (IDDSI Type 3)

Using the methodology described above a Type 3 formulation was made up as per Table 12a below:

| | (3) Moderately Thick | |
|---|---|---|
| Mass | grams | % |
| Orange juice | 50.00 | 97.83 |
| Potassium sorbate | 0.02 | 0.04 |
| Pectin | 0.16 | 0.31 |
| Calcium gluconate | 0.22 | 0.43 |
| Sodium alginate | 0.50 | 0.98 |
| Agar | 0.01 | 0.02 |
| Sodium hydroxide | 0.20 | 0.39 |
| pH | ND | |
| | IDDSI | >8.0 |
| Amount left in | Results | 9.0 |
| syringe (mL) | | |

IDDSI Type 3 is described as a liquid that can be drunk from a cup, can be eaten with a spoon, can be swallowed directly and has no lumps. The IDDSI Flow Test states that the test liquid should flow through a 10 mL slip tip syringe leaving >8 mL in the syringe after 10 seconds. The Example 6a formulation has 9.0 mL of liquid left in the syringe.

### Example 6b (IDDSI Type 3)

Using the methodology described above a Type 3 formulation was made up as per Table 12b below:

| | 3) Moderately Thick | |
|---|---|---|
| Mass | grams | % |
| Water | 59.01 | 98.35 |
| Potassium sorbate | 0.03 | 0.05 |
| Pectin | 0.17 | 0.28 |
| Calcium gluconate | 0.13 | 0.21 |
| Sodium alginate | 0.59 | 0.98 |
| Agar | 0.07 | 0.11 |
| Citric acid | 0.01 | 0.02 |
| pH | 5.50 | |
| Amount left in | IDDSI | >8.0 |
| syringe (mL) | Results | 8.8 |

IDDSI Type 3 is described as a liquid that can be drunk from a cup, can be eaten with a spoon, can be swallowed directly and has no lumps. The IDDSI Flow Test states that the test liquid should flow through a 10 mL slip tip syringe leaving >8 mL in the syringe after 10 seconds. The Example 6b formulation has 8.8 mL of liquid left in the syringe.

### Example 7a (IDDSI Type 4)

Using the methodology described above a Type 4 formulation was made up as per Table 13a below:

| | (4) Extremely Thick | |
|---|---|---|
| Mass | grams | % |
| Orange juice | 50.00 | 97.16 |
| Potassium sorbate | 0.02 | 0.034 |
| Pectin | 0.05 | 0.10 |
| Calcium gluconate | 0.22 | 0.43 |
| Sodium alginate | 1.00 | 1.94 |
| Agar | 0.05 | 0.10 |
| Sodium hydroxide | 0.12 | 0.23 |
| pH | 5.09 | |
| Amount left in | IDDSI | Spoon, fork |
| syringe (mL) | | drip & |
| | | pressure |
| | Results | PASS ALL |

### Example 7b (IDDSI Type 4)

Using the methodology described above a Type 4 formulation was made up as per Table 13b below:

| | 4) Extremely Thick | |
|---|---|---|
| Mass | grams | % |
| Water | 58.94 | 98.24 |
| Potassium sorbate | 0.03 | 0.05 |
| Pectin | 0.14 | 0.23 |
| Calcium gluconate | 0.14 | 0.24 |
| Sodium alginate | 0.53 | 0.88 |
| Agar | 0.2 | 0.34 |
| Citric acid | 0.01 | 0.02 |
| pH | 5.00 | |
| Amount left in | IDDSI | Spoon, fork drip |
| syringe (mL) | | & pressure |
| | Results | PASS ALL |

IDDSI Type 4 is described as a puree that can be eaten with a spoon, cannot be drunk from a cup because it does not flow easily, cannot be sucked through a straw and has no lumps. The IDDSI Flow Test is not applicable for Texture (4) but Fork Pressure Test, Fork Drip Test and Spoon Tilt Test is.

The Fork Pressure Test states that the puree should be smooth with no lumps and minimal granulation. When a fork is pressed on the surface of the puree, the prongs of a fork can make a clear pattern on the surface, or the food retains the indentation from the fork. The Fork Drip Test states that the sample sits in a pile above the fork and a small amount may flow through and form a short tail below the fork prongs but does not drip continuously through the prongs. The Spoon Tilt Test states that the product should be cohesive enough to hold its shape on the spoon and a spoonful must plop off the spoon if turned sideways. All three of the test criterion are met by the Example 7a and 7b formulation.

Before arriving at the preferred formulations Applicant noted that the selected cation, calcium chloride, often appeared “speckled” and contained “clumps” which were more apparent in the “thicker” formulations. They therefore tested and compared calcium chloride with alternative cations including:
a. Magnesium chloride; and
b. Calcium gluconate.

The results of these tests (see Example 8 below) showed Calcium gluconate to be strongly favoured for the orange juice-based gels.

### Example 8

TABLE 14

| Gelling agents | | | |
|---|---|---|---|
| Agar | 0.02% | 0.02-1.5% | 0.02% |
| Alginate | 1.90% | 1.90% | 0.50-1.90% |
| Low methoxy | 0.30% | 0.30% | 0.30% |
| pectin | | | |
| Divalent cation | Calcium | Magnesium | Calcium |
| | chloride | chloride | Gluconate |
| | 0.10-0.80% | 0.10-0.80% | 0.20-1.20% |
| Non gelling | | | |
| agents | | | |
| pH-e.g. sodium | 0.30-0.40% | 0.30-0.40% | 0.20-0.50% |
| hydroxide | | | |
| Stabiliser e.g. | 0.04% | 0.04% | 0.04% |
| potassium sorbate | | | |
| Water | to 100% | to 100% | to 100% |
| Observation | Speckled | Less | Fewest |
| | and lumps | Speckles | speckles, no |
| | | and lumps | lumps and |
| | | but long gel | good gel |
| | | time | time |

The developed formulations containing calcium chloride produced speckles and clumps, which was not desirable. Calcium chloride is a common ingredient used to cross-link with alginate. Due to its high solubility, it results in rapid and poorly controlled gelation. A calcium salt with a lower water solubility, namely calcium gluconate, had significantly less speckles and clumps, outperforming the other salts significantly.

Magnesium ions formed very slow bonds and networks with alginate over a period of 2-3 hours. However, whilst magnesium chloride also produced fewer speckles and clumps it proved impractical due to its slower gel formation.

1. A base gel formulation, conforming with the International Dysphagia Diet Standardisation Initiative (IDDS) 2019, comprising:
a plurality of gelling agents;
water;
a pH modifying agent,
a preservative;
the plurality of gelling agents comprises one each of:
agar;
alginate, as a primary gelling agent; and
low methoxy pectin
together with at least one divalent cation.

2. The base gel formulation as claimed in claim 1, wherein the plurality of gelling agents are present in the amounts, by weight, based on the total weight of the base gel, of:
agar 0.01 to 0.60 weight %;
alginate 0.05 to 2.00 weight %;
low methoxy pectin 0.01 to 0.50 weight %; and
the at least one divalent cation 0.05 to 1.50 weight %.

3. The base gel formulation as claimed in claim 2, wherein the plurality of gelling agents are present in the amounts, by weight, based on the total weight of the base gel, of:
agar 0.01 to 0.20 weight %;
alginate 0.05 to 0.80 weight %;
low methoxy pectin 0.2 to 0.40 weight %; and
the at least one divalent cation 0.10 to 1.20 weight %; and
the gel is a Texture 1 gel as defined by IDDSI Flow test criteria.

4. The base gel formulation as claimed in claim 2, wherein the plurality of gelling agents are present in the amounts, by weight, based on the total weight of the base gel, of:
agar 0.01 to 0.20 weight %;
alginate 0.35 to 1.00 weight %;
low methoxy pectin 0.2 to 0.40 weight %; and
the at least one divalent cation 0.10 to 0.80 weight %; and
the gel is a Texture 2 gel as defined by IDDSI Flow test criteria.

5. The base gel formulation as claimed in claim 2, wherein the plurality of gelling agents are present in the amounts, by weight, based on the total weight of the base gel, of:
agar 0.01 to 0.2 weight %;
alginate 0.40 to 1.60 weight %;
low methoxy pectin 0.05 to 0.50 weight %; and
the at least one divalent cation 0.05 to 0.65 weight %; and
the gel is a Texture 3 gel as defined by IDDSI Flow test criteria.

6. The base gel formulation as claimed in claim 2, wherein the plurality of gelling agents are present in the amounts, by weight, based on the total weight of the base gel, of:
agar 0.05 to 0.60 weight %;
alginate 0.10 to 2.00 weight %;
low methoxy pectin 0.01 to 0.30 weight %; and
the at least one divalent cation 0.10 to 1.50 weight %; and
the gel is a Texture 4 gel as defined by IDDSI Flow test criteria.

7. The base gel formulation as claimed in claim 1, wherein the at least one divalent cation comprises calcium ions.

8. The base gel formulation as claimed in claim 7, wherein the calcium ions are present as calcium gluconate.

9. The base gel formulation as claimed in claim 1, wherein the pH modifying agent maintains the pH at between 4 and 6.

10. The base gel formulation as claimed in claim 9, wherein the pH modifying agent is sodium hydroxide or citric acid.

11. The base gel formulation as claimed in claim 1, wherein the preservative is potassium sorbate.

12. The base gel formulation as claimed in claim 2, which when packaged in a container facilitates uptake of the container's contents by drinking or sucking.

13. The base gel formulation as claimed in claim 12, wherein the container is a pouch, sachet or straw.

14. A method of providing a patient with dietary and/or pharmaceutical ingredients comprising: including the ingredients in a base gel formulation and allowing the patient to drink the base gel formulation, the base gel formulation conforming with the International Dysphagia Diet Standardisation Initiative (IDDS) 2019 and including:
a plurality of gelling agents;
water;
a pH modifying agent,
a preservative;
the plurality of gelling agents comprises one each of:
agar;
alginate, as a primary gelling agent;
low methoxy pectin
together with at least one divalent cation; and
wherein the plurality of gelling agents are present in the amounts, by weight, based on the total weight of the base gel, of:
agar 0.01 to 0.60 weight %;
alginate 0.05 to 2.00 weight %;
low methoxy pectin 0.01 to 0.50 weight %; and
the at least one divalent cation 0.05 to 1.50 weight %.

15. The method as claimed in claim 14, wherein the plurality of gelling agents are present in the amounts, by weight, based on the total weight of the base gel, of:
agar 0.01 to 0.20 weight %;
alginate 0.05 to 0.80 weight %;
low methoxy pectin 0.2 to 0.40 weight %; and
the at least one divalent cation 0.10 to 1.20 weight %; and
the gel is a Texture 1 gel as defined by IDDSI Flow test criteria.

16. The method as claimed in claim 14, wherein the plurality of gelling agents are present in the amounts, by weight, based on the total weight of the base gel, of:
agar 0.01 to 0.20 weight %;
alginate 0.35 to 1.00 weight %;
low methoxy pectin 0.2 to 0.40 weight %; and
the at least one divalent cation 0.10 to 0.80 weight %; and
the gel is a Texture 2 gel as defined by IDDSI Flow test criteria.

17. The method as claimed in claim 14, wherein the plurality of gelling agents are present in the amounts, by weight, based on the total weight of the base gel, of:
agar 0.01 to 0.2 weight %;
alginate 0.40 to 1.60 weight %;
low methoxy pectin 0.05 to 0.50 weight %; and
the at least one divalent cation 0.05 to 0.65 weight %; and
the gel is a Texture 3 gel as defined by IDDSI Flow test criteria.

18. The method as claimed in claim 14, wherein the base gel further includes a flavouring.

19. The method as claimed in claim 14, wherein the at least one divalent cation comprises calcium ions.

20. The base gel formulation as claimed in claim 1, further comprising a flavouring.
